(19) United States
(12) Patent Application Publication
(10) Pub. No.: US 2004/0238114 A1
(43) Pub. Date: Dec. 2, 2004

(54) Air bag system and method of forming the same

(75) Inventors: Luis Lorenzo, Midland, MI (US); David L. Chapman, Lake Orion, MI (US); Vikas Gupta, East Amherst, NY (US); Steve J. Rogers, Pinckney, MI (US)

Correspondence Address: DOBRUSIN & THENNISCH PC, 401 S OLD WOODWARD AVE, SUITE 311, BIRMINGHAM, MI, 48009, US

(73) Assignee: Dow Global Technologies Inc., Midland, MI

(21) Appl. No.: 10/857,825

(22) Filed: Jun. 1, 2004

Related U.S. Application Data
(60) Provisional application No. 60/475,200, filed on Jun. 2, 2003.

(51) Int. Cl. B32B 31/00

(52) U.S. Cl. 156/292; 156/330.9

(57) ABSTRACT

There is disclosed an air bag system and a method of forming the same. The system preferably includes a first panel portion and a second panel portion that are adhered to each other to form a laminate member. An air bag of the air bag system is preferably configured for opening the laminate member upon inflation of the air bag.

### CLAIM OF BENEFIT OF FILING DATE

The present application claims the benefit of the filing date of U.S. Provisional Application Ser. No. 60/475,200, filed Jun. 2, 2003, hereby incorporated by reference.

### TECHNICAL FIELD

The present invention relates to an improved air bag system and a method of forming the same.

### BACKGROUND OF INVENTION

Generally, it is desirable for air bag systems to be assembled within a variety of locations in a transportation vehicle (e.g., an automotive vehicle) and the systems are typically integrated with various components of the vehicle. In certain instances, however, it may be desirable to form these various components with materials that may be incompatible with the air bag systems. For example, it can be desirable to form components of a vehicle out of relatively hard or relatively non-ductile materials. However, such materials can cause difficulties as air bag doors since pressure applied by an air bag can result in unpredictable ruptures in the materials.

As a result of these incompatibilities, it can become desirable or even necessary to adapt the various components, the air bag systems or both to promote their compatibility with each other. Thus, according to one embodiment, the present invention provides an air bag system that includes components or members formed of one or more particularly desirable materials wherein the components have been adapted for employment with the air bag system.

### SUMMARY OF THE INVENTION

The present invention provides an air bag system providing a first panel portion formed of a first material. The first panel portion is typically part of a first member and typically includes a corresponding surface formed of the first material having a relatively low ductility. In preferred embodiments: the first member is an instrument panel of an automotive vehicle; the first material has elongation at break of between about 0.1% and about 100%; and the first panel portion is at least partially defined by cavities forming seams thereabout or a combination thereof. The air bag system also provides a second panel portion formed of a second material. The second panel portion is typically part of a second member and typically includes a corresponding surface formed of the second material having a ductility greater than (e.g. 50% greater than) the ductility of the first material. In preferred embodiments: the second material provides the corresponding surface of the second panel portion as a low energy surface having a surface energy of less than 45 mJ/m²; the second material preferably has an elongation or break of between about 1% and about 1000% or both. The corresponding surface of the first panel portion is typically adhered to the corresponding surface of the second panel portion with an adhesive to form a laminate member. According to a preferred embodiment, the adhesive is an organoborane/amine complex. The air bag system also typically provides an air bag configured to open the laminate member upon inflation of the air bag.

### DESCRIPTION OF THE DRAWINGS

FIG. 1 is an assembled sectional view of a portion of an exemplary air bag system according to a preferred embodiment of the present invention.

FIG. 2 is an exploded perspective view of the exemplary air bag system according to FIG. 1.

FIG. 3 is a sectional view of the air bag system of FIG. 1 after deployment of an air bag.

### DETAILED DESCRIPTION OF THE PREFERRED EMBODIMENT

The present invention is predicated upon the provision of an air bag system having a member formed of a laminate structure having a first layer and a second layer. Preferably the member is a door of the air bag system although not required. One of the layers of the member is preferably formed of a relatively hard and/or non-ductile material. The other layer is preferably formed of a relatively soft and/or ductile material. It is contemplated, however, that both of the layers may be formed of a relatively soft and/or ductile material or a relatively hard or non-ductile material. The first and the second layers typically include at least one corresponding surface such that the corresponding surface of the first layer can be attached (e.g., adhered) to the corresponding layer of the second layer. In this manner, the more ductile layer can assist in maintaining the structural continuity of the relatively non-ductile material, particularly under dynamic load conditions. The corresponding surfaces are preferably attached to each other with an adhesive as further described herein. Moreover, in one embodiment, at least one of the corresponding surfaces of the first and second layers is preferably a relatively low energy surface. Advantageously, the adhesive is capable of adhering to the low energy surface.

It is contemplated that the laminate material of the air bag system of the present invention may be employed for various articles of manufacture. It has been found, however, that the laminate and the system are particularly effective for transportation vehicles (e.g., automotive vehicles). It is also contemplated that the air bag system may be employed in various locations of the vehicle, although, it has been found that the system is particularly effective as a passenger side air bag integrated with an instrument panel.

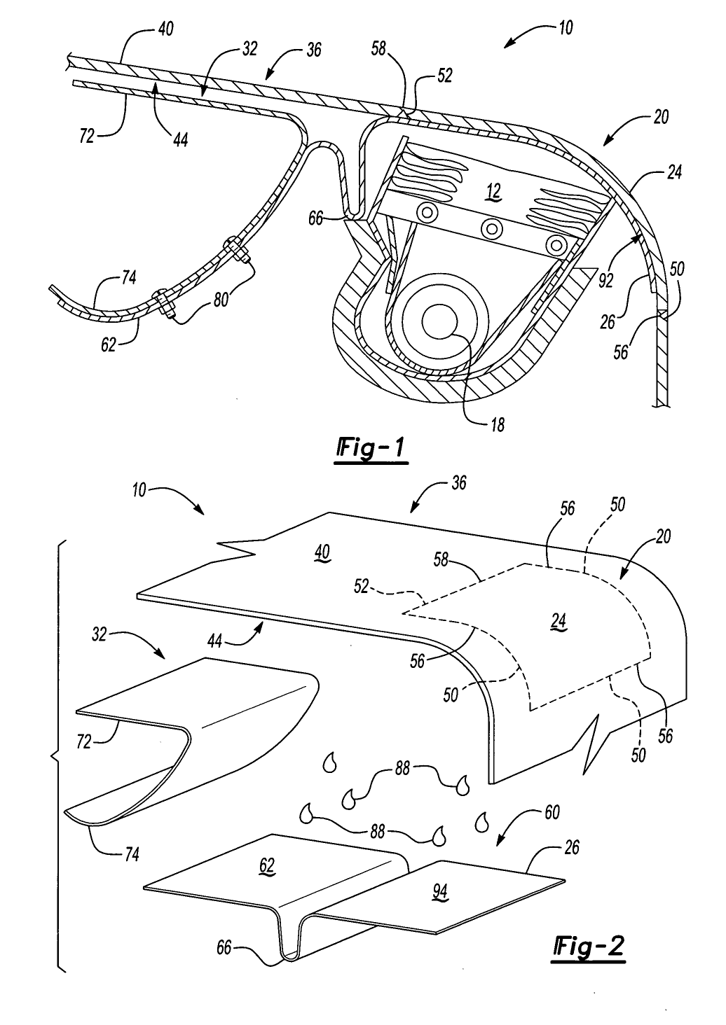

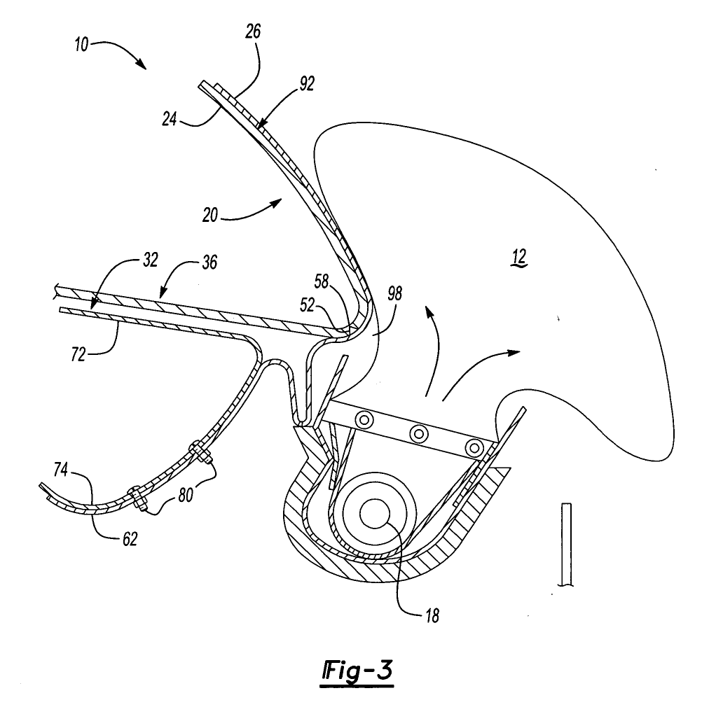

Referring to FIG. 1-3, there is illustrated an exemplary air bag system 10 according to one embodiment of the present invention. As illustrated, the air bag system 10 is integrated as part of a “dashboard” or “instrument panel” of an automotive vehicle. It is contemplated, however, that the air bag system may be integrated as part of various automotive components such as a seat assembly, a roof structure, a pillar structure, a door assembly, a steering wheel assembly or the like.

The air bag system 10 typically includes an air bag 12, an inflator 18 and a laminate member 20 having a first panel portion 24 and a second panel portion 26. Optionally, the air bag system 10 can include a connector 32.

As discussed, the air bag system 10 is illustrated as an instrument panel assembly. Thus, the first panel portion 24 is provided by a first member 36, which is shown as an instrument panel. The first member 36 has a first surface 40 opposite a second surface 44. In the particular embodiment shown, the first surface 40 can be referred to as the A-side or A-surface (i.e., the side or surface of the first member 36 that is typically visible to an occupant of the automotive vehicle). Likewise, the second surface 44 of the first member 36 can be referred to as the B-side or B-surface (i.e., the side or surface of the first member 36 that is typically not visible to the occupant of the automotive vehicle).

The first panel portion 24 can be defined in a variety of manners depending on the technique used to form it. In FIGS. 1-3, the first panel portion 24 is defined by one or more cavities 50, 52 that extend entirely or partially about the panel portion 24 thereby forming seams 56, 58 (i.e., relatively thin elongated portions of the first members 36). Preferably, the cavities 50, 52 extend into the first member 36 from the second surface 44 such that the first surface 40 is substantially free of any cavities defining any air bag door. However, it is also contemplated that cavities may extend into the first member 36 from the first surface 40. As shown, the first panel portion 24 is substantially rectangular with three cavities 50 that form tear seams 56 and one cavity 52 that forms a hinge seam 58. Preferably, the tear seams 56 extend further into the first member 36 than the hinge seam 58, although not required. Such seams may be directly molded (e.g., injection, compression, blow or otherwise molded) into the panel portion or a cutting operation such as laser scoring may be employed for removing material from or for moving material of the panel portion to form the seams.

The first member 36 and first panel portion 24 may be formed of a variety of materials and the materials may be the same or different. In one preferred embodiment, the first member 36, the first panel portion 24 or both are made from a plastic material (e.g., a thermoplastic material). In a particularly preferred embodiment, the first member 36, the first panel portion 24 or both are made from a high strength thermoplastic resin selected from styrenics, polyamides, polyolefins, polycarbonates, polyesters or mixtures thereof. Still more preferably they are selected from the group consisting of acrylonitrile butadiene styrene, polycarbonate/acrylonitrile/butadiene styrene, polycarbonate, polyphenylene oxide/polystyrene, polybutylene terephthalate, polyphenylene oxide, polyphenylene ether, syndiotactic polystyrene, thermoplastic olefin (e.g. ethylene alpha olefin), polybutylene terephthalate/polycarbonate, polyamide (e.g., nylon), polyesters, polypropylene, polyethylene, polyethylene terephthalates, mixtures, alloys and blends thereof.

Although not necessarily required, it is preferable for the material or materials that form the first member 36, the first panel portion 24 or both to be relatively hard or non-ductile. In a preferred embodiment, the material or materials have an elongation at break at about 20° C. of between about 0.1% and about 100%, more preferably between about 0.5% and about 50%, and still more preferably between about 1% and about 10%.

The first member 36 and the first panel portion 24 may be formed using a variety of techniques. Thus, for example, the member 36 and portion 24 may be formed, molded, machined or otherwise configured to the desired shape. According to one preferred embodiment, the first member 36 is molded in a manner that directly forms the cavities during molding to define the first panel portion 24. Where the member and portion are plastic, it is possible to use any suitable plastic fabrication technique including, without limitation, injection molding (including but not limited to external or internal gas injection molding), blow molding, compression molding, rotational molding, thermoforming, extruding, vacuum forming, foaming-in-place, or otherwise. One or more other fabrication techniques can also be employed such as insert molding, over-molding or a combination thereof. In another preferred embodiment, the member 36 is molded and a subsequent operation is employed for forming the cavities that define the first panel portion 24. The subsequent operation may be selected from heat staking, cutting, slicing, laser scoring or any other forming technique. Preferably, the first member 36 and first panel portion 24 are molded together of a singular material, but such is not required.

The second panel portion 26 can be defined in a variety of manners depending on the technique used to form it. In FIGS. 1-3, the second panel portion 26 is a rectangular portion of a second member 60. In the particular embodiment depicted, the second member 60 includes a base portion 62 opposite the second panel portion 26. The second member 60 is also shown to include a hinge 66 between the second panel portion 26 ad the base portion 62. As shown, the hinge 66 is shaped as a ripple, but may be shaped according to a variety of configurations.

The second member 60 and the second panel portion 26 may be formed of a variety of materials and the material may be the same or different. In one preferred embodiment, the second member 60, the first panel portion 26 or both are made from a plastic material, an elastomer material or a combination thereof. (e.g., a thermoplastic material). In a particularly preferred embodiment, the member 60, the portion 26 or both are formed of a thermoplastic elastomer. Exemplary thermoplastic elastomers include styrene-, olefin-, PVC-, urethane-, or polyester-based elastomers. Other thermoplastic elastomers include flexible polyolefins (FPOs), polyolefin elastomers (POEs), thermoplastic ethylene propylene rubber (EPR), thermoplastic ethylene propylene diene modified rubber (EPDM), polyether block amide elastomers, thermoplastic copolyamides, thermoplastic copolyesters and thermoplastic polyurethanes based on either a polyester or a polyether formulation.

Although not necessarily required, it is preferable for the material or materials that form the second member 60, the second panel portion 26 or both to be relatively flexible, ductile or the like. For example, it is contemplated that the values for ductility or elongation at break for the material at the second member 60 of about 20° C. are at least 10%, more preferably at least 50% and even more preferably at least 100% greater than those values for the material of the first member. In a preferred embodiment, the material or materials for the second member have an elongation at break at about 20° C. of between about 1% and about 1000%, more preferably between about 2% and about 500%, and still more preferably between about 4% and about 100%.

The second member 60 and the first panel portion 26 may be formed using a variety of techniques. Thus, for example, the member 60 and portion 26 may be formed, molded, machined or otherwise configured to the desired shape. Where the member and portion are plastic or thermoplastic elastomer, it is possible to use any suitable plastic fabrication technique including, without limitation, injection molding (including but not limited to external or internal gas injection molding), blow molding, compression molding, rotational molding, thermoforming, extruding, vacuum forming, foaming-in-place, or otherwise. One or more other fabrication techniques can also be employed such as insert molding, over-molding or a combination thereof.

The connector 32 may be formed in a variety of shapes and configurations and may be formed of a variety of materials (e.g., polymeric materials such as plastics, metals such as metal stampings or metal (e.g., aluminum) extrusions or the like). In the illustrated embodiment, the connector 32 include a first portion 72 that is generally planar and a second portion 74 that is generally arcuate and extends away from the first portion 72. Preferably, the connector 32 acts as a chute or director for the air bag 12 upon deployment thereof.

It is contemplated that the materials for forming the connector, the members or the panel portions may include fillers or reinforcement materials. For example, the polymeric materials may incorporate natural, mineral, fibrous or other fillers of various shapes and sizes for providing reinforcing, stiffening or other characteristics to the structures. According to one preferred embodiment, one or more of the materials incorporates long or short glass fibers.

The air bag system 10 may be assembled as desired. Various combinations of the air bag 12, the inflator 18, the first panel portion 24, the second panel portion 26, the first member 36, the second member 60 and the connector 32 may be attached to each other or unattached and may be located as needed or desired relative to each other. For example, the aforementioned component may be adhered to each other, integrally formed with each other, interference fit to each other, fastened to each other with fasteners or a combination thereof. Exemplary mechanical fasteners might include screws, clips, rivets, interlocking devices combinations thereof or the like. Moreover, such attachments may be integrally formed with or separate from the aforementioned components. Alternatively or additionally, the aforementioned components may be integrated together by molding them together according to one of the molding techniques described herein. As other alternatives or other additions, heat staking, vibrational welding, sonic welding, laser welding, hot plate welding combinations thereof or the like may be employed.

In the illustrated embodiment, the connector 32 is attached (e.g., adhered or mechanically fastened) to both the first member 36 and second member 60. Although, these members 36, 60 may be attached to the connector 32 as desired, it is preferable for attachments (e.g., mechanical fasteners) 80 to attach the base portion 62 of the first member 60 to the second portion 74 of the connector 32.

In a highly preferred embodiment, the first panel portion 24 is adhered to the second panel portion 26 with an adhesive 88 such that the second panel portion 26 is substantially coextensive with the first panel portion 24. As shown, the first panel portion 24 and the second panel portion 26 both respectively provide corresponding surfaces 92, 94. In the preferred embodiment, the corresponding surface 92 of the first panel portion 24 is attached to the corresponding surface 94 of the second panel portion by locating an adhesive 88 between the surfaces. Such an adhesive may be dabbed, poured, brushed, placed or otherwise applied to one or more of the corresponding surfaces followed by moving the corresponding surfaces 92, 94 toward each other.

In one embodiment, the adhesive is a urethane based adhesive, and more preferably a urethane adhesive. Alternatively, the adhesive may include a functional component selected from acrylonitrile butadiene styrene (ABS), polycarbonate (PC), or a mixture thereof (e.g. PC-ABS). In a further alternative embodiment the adhesive is a silane adhesive, a silicone adhesive or a mixture thereof. In yet another embodiment, the adhesive is an acrylic adhesive. The adhesive may also be epoxy based. It may include polyolefinics, styrenics, acrylics or mixtures thereof. In yet another embodiment, a preferred adhesive includes alkyl borane. Examples of suitable adhesives are disclosed in commonly owned U.S. patent Ser. No. 09/466,321 (filed Dec. 17, 1999) and patent publication numbers 20020058764 and 20030001410 expressly incorporated herein by reference for all purposes. Any such adhesive may include suitable performance modifiers including art disclosed tackifiers, elastomers, impact modifiers, or the like.

In one highly preferred embodiment, a two part, organoborane/amine comple adhesive or other adhesive is employed for adhesively securing the first panel portion to the second panel portion. Advantageously, it has been found that the adhesive is capable of adhering to low energy surfaces. Additionally, the adhesive may be capable of adhereing to a surface without having to treat (e.g., heat, clean, expose to plasma or the like) any surfaces of the panel portions prior to adhesion.

In an especially preferred embodiment of the invention, the members 36, 60, the panel portions 24, 26 or a combination thereof are formed of material that provides one or more of the corresponding surfaces 92, 94 as having a surface energy of less than 45 mJ/m². In one particularly preferred embodiment, the second panel portion 26 of the second member 60 is formed from one of the thermoplatic elastomers described herein and the thermoplastic elastomer provides the corresponding surface 94 of the second panel portion 26 as a low energy surface having a surface energy of less than 45 mJ/m².

In one preferred embodiment, the adhesive is derived from a polymerizable composition comprising

a. an organoborane/amine complex;

b. one or more of monomers, oligomers or polymers having olefinic unsaturation which is capable of polymerization by free radical polymerization; and, optionally

c. a compound which causes the said complex to disassociate so as to release the borane to initiate polymerization of one or more of monomers, oligomers or polymers having olefinic unsaturation.

Adhesives and polymerizable compositions that are especially preferred for use in the present invention are disclosed in International Patent Application No. PCT/US00/33806 expressly incorporated herein by reference for all purposes.

The amines used to complex the organoborane compound can be any amines which complex the organoborane and which can be decomplexed when exposed to a decomplexing agent. Preferred amines include the primary or secondary amines or polyamines containing primary or secondary amine groups, or ammonia, as disclosed in Zharov U.S. Pat. No. 5,539,070 at column 5 lines 41 to 53, incorporated herein by reference, Skoultchi U.S. Pat. No. 5,106,928 at column 2 line 29 to 58 incorporated herein by reference, and Pocius U.S. Pat. No. 5,686,544 column 7, line 29 to Column 10 line 36 incorporated herein by reference; monthanolamine, secondary dialkyl diamines or polyoxyalkylenepolyamines; and amine terminated reaction products of diamines and compounds having two or more groups reactive with amines as disclosed in Deviny U.S. Pat. No. 5,883,208 at column 7 line 30 to column 8 line 56, incorporated herein by reference. With respect to the reaction products described in Deviny the preferred diprimary amines include alkyl diprimary amines, aryl diprimary amines, alkyaryl diprimary amines and polyoxyalkylene diamines; and compounds reactive with amines include compounds which contain two or more groups of carboxylic acids, carboxylic acid esters, carboxylic acid halides, aldehydes, epoxides, alcohols and acrylate groups. Preferred amines include n-octylamine, 1,6-diaminohexane (1,6-hexane diamine), diethylamine, dibutyl amine, diethylene triamine, dipropylene diamine, 1,3-propylene diamine (1,3-propane diamine), 1,2-propylene diamine, 1,2-ethane diamine, 1,5-pentane diamine, 1,12-dodecanediamine, 2-methyl-1,5-pentane diamine, 3-methyl-1,5-pentane diamine, triethylene tetraamine, diethylene triamine. Preferred polyoxyalkylene polyamines include polyethyleneoxide diamine, polypropyleneoxide diamine, triethylene glycol propylene diamine, polytetramethyleneoxide diamine and polyethyleneoxidecopolypropyleneoxide diamine.

In particular, the amine in the organoborane/amine complex is suitably selected from the group of amines having an amidine structural component; aliphatic heterocycles having at least one nitrogen in the heterocyclic ring wherein the heterocyclic compound may also contain one or more nitrogen atoms, oxygen atoms, sulphur atoms, or double bonds in the heterocycle; primary amines which in addition have one or more hydrogen bond accepting groups wherein there are at least two carbon atoms, preferably at least three carbon atoms, between the primary amine and the hydrogen bond accepting group, such that due to inter- or intramolecular interactions within the complex the strength of the B—N bond is increased; and conjugated imines.

Preferred hydrogen bond accepting groups include the following: primary amines, secondary amines, tertiary amines, ethers, halogens, polyethers or polyamines. Heterocycle as used herein refers to a compound having one or more aliphatic cyclic rings of which one of the rings contains nitrogen. The amidines or conjugated imines may be straight or branched chain or cyclic.

In a further embodiment, the amine which is complexed with the organoborane is suitably a conjugated imine. Any compound with a conjugated imine structure, wherein the imine has sufficient binding energy with the organoborane as described in International Patent Application No. PCT/US00/33806 may be used. The conjugated imine can be a straight or branched chain imine or a cylic imine. Among preferred conjugated imines are 4-dimethylaminopyridine; 2,3-bis(dimethylamino)cycl-opropeneimine; 3-(dimethylamine)acroleinimine; 3-(dimethylamino)methacrole-inimine. It is also contemplated that the adhesive may include or be based upon one or more inorganic material. As such, the adhesive may include or be based upone one or more borane or borate salts.

Preferably the molar ratio of amine compound to organoborane compound is from 1.0:1.0 to 3.0:1.0. Below the ratio of about 1.0:1.0 there may be problems with polymerization, stability of the complex and adhesion. Greater than about a 3.0:1.0 ratio may be used although there may not be additional benefit from using a ratio greater than about 3.0:1.0. If too much amine is present, this may negatively impact the stability of the adhesive or polymer compositions. Preferably the molar ratio of amine compound to organoborane compound is from 2.0:1.0 to 1.0:1.0.

Once the adhesive 88 has been applied, it will typically require some amount of time to cure (e.g., part cure, full cure, cure on demand, air cure, heat cure, moisture cure, chemical cure, light cure, or the like). Preferably, the adhesive cures at about room temperature (e.g., between about 20° C. to about 30° C.), but may be exposed to elevated or lowered temperatures or other stimuli for accelerating or slowing cure times. During cure, it may be desirable to employ fasteners (e.g., push-pins, clips or the like) for holding the panel portions together. Such fasteners may be removable or may be intended to assist in securing the panel portion together during use.

Additionally or alternatively, the corresponding surfaces or other portions of the panel portions 24, 26, the members 36, 60 or both may be formed (e.g., molded) to have interlocking features for attaching the structures together during adhesive cure or any other time. For example, a corresponding surface of one panel poriton may include one or more openings (e.g., cavities) for receiving one or more protrusions of a corresponding surface of the other panel portion. It is also contemplated that the corresponding surfaces or other portions of the panel portion 24, 26, the members 36, 60 or both may have a primer applied thereto to assist in allowing the adhesive to adhere thereto.

In operation, the air bag 12 of the system 10 may be deployed (i.e., inflated) upon various occurrences such as collisions, rapid decelerations or the like. Upon deployment, the air bag 12 places pressure upon the laminate member 20, which, in turn, causes the laminate member 20 to open (e.g., by pivoting) and provide an opening 98 (e.g., a through-hole) in the first member 36 through which the air bag 12 may travel. In the embodiment shown, the tear seams 56 are ruptured such that the laminate member 20 may rotate about the hinge 66, the hinge seam 58 or both.

Advantageously, when the second portion 26 is formed of a relatively ductile material and the first portion 24 is formed of a relatively non-ductile material, the second portion 26 provides an added amount of structural continuity or integrity to the first portion 24. In this manner, the laminate member 20 can more consistently maintain structural continuity during opening thereof by the air bag 12.

The foregoing discussion discloses and describes merely exemplary embodiments of the present invention. One skilled in the art will readily recognize from such discussion and from the accompanying drawings and claims, that various changes, modifications and variations can be made therein without departing from the spirit and scope of the invention as defined in the following claims. In particular regard to the various functions performed by the above described components, assemblies, devices, compositions, etc., the terms used to describe such items are intended to correspond, unless otherwise indicated, to any item that performs the specified function of the described item, even though not necessarily structurally equivalent to the disclosed structure. In addition, while a particular feature of the invention may have been described above with respect to only one of the embodiments, such feature may be combined with one or more other features of other illustrated embodiments.

What is claimed is:

1. A method of forming air bag system, comprising:
providing a first panel portion formed of a first material, the first panel portion having a corresponding surface formed of the first material;
providing a second panel portion formed of a second material, the second panel portion having a corresponding surface formed of the second material;
adhering the corresponding surface of the first panel portion to the corresponding surface of the second panel portion with an adhesive to form a laminate member; and
providing an air bag configured to open the laminate member upon inflation.

2. A method of forming air bag system, comprising:
providing a first member having a first panel portion formed of a first material, the first panel portion having a corresponding surface formed of the first material, the first panel portion being at least partially defined by one or more cavities that form seams about the first panel portion, the first member being an instrument panel;
providing a second member, the second member including a second panel portion formed of a second material, the second panel portion having a corresponding surface formed of the second material, the second material providing the corresponding surface of the second panel portion as a low energy surface having a surface energy of less than 45 mJ/m²;
adhering the corresponding surface of the first panel portion to the corresponding surface of the second panel portion with an adhesive to form a laminate member, the adhesive being an organoborane/amine complex; and
providing an air bag configured to open the laminate member upon inflation of the air bag.

3. A method of forming air bag system, comprising:
providing a first member having a first panel portion formed of a first material, the first panel portion having a corresponding surface formed of the first material, the first member being an instrument panel, the first material being having a ductility of between about 0.1% and about 100%;
providing a second member, the second member including second panel portion formed of a second material, the second panel portion having a corresponding surface formed of the second material, the second material providing the corresponding surface of the second panel portion as a low energy surface having a surface energy of less than 45 mJ/m², the second material having a ductility of between about 1% and about 1000%;
adhering the corresponding surface of the first panel portion to the corresponding surface of the second panel portion with an adhesive to form a laminate member, the adhesive being an organoborane/amine complex;
providing an air bag configured to open the laminate member upon inflation of the air bag.

4. A method according to claim 1 wherein at least one of the corresponding surfaces of the first panel portion and the corresponding surface of the second panel portion is a low energy surface and wherein the adhesive is capable of bonding to a low energy surface.

5. A method according to claim 2 wherein the second panel portion is formed of a thermoplastic elastomer selected from a styrene-based elastomer, olefin-based elastomer, PVC-based elastomer, urethane-based elastomer, polyester-based elastomer, or combinations thereof.

6. A method according to claim 3 wherein the second panel portion is formed of a thermoplastic elastomer selected from a styrene-based elastomer, olefin-based elastomer, PVC-based elastomer, urethane-based elastomer, polyester-based elastomer, or combinations thereof.

7. A method according to claim 1 wherein the first material includes a fiber.

8. A method according to claim 2 wherein the first material includes a fiber.

9. A method according to claim 3 wherein the first material includes a fiber.

10. A method as in claim 1 wherein the first material is selected from a polyamide, a polypropylene, a styrenic or a combination thereof.

11. A method as in claim 2 wherein the first material is selected from a polyamide, a polypropylene, a styrenic or a combination thereof.

12. A method as in claim 3 wherein the first material is selected from a polyamide, a polypropylene, a styrenic or a combination thereof.

13. A method according to claim 1 wherein the adhesive comprises an organoborane/amine complex and one or more of monomers, oligomers or polymers having olefinic unsaturation which is capable of polymerization by free radical polymerization.

14. A method according to claim 2 wherein the adhesive comprises an organoborane/amine complex and one or more of monomers, oligomers or polymers having olefinic unsaturation which is capable of polymerization by free radical polymerization.

15. A method according to claim 3 wherein the adhesive comprises an organoborane/amine complex and one or more of monomers, oligomers or polymers having olefinic unsaturation which is capable of polymerization by free radical polymerization.

16. A method according to claim 13 wherein the organoborane part of the organoborane/amine complex is selected from a trialkyl borane and an alkyl cycloalkyl borane.

17. A method according to claim 14 wherein the organoborane part of the organoborane/amine complex is selected from a trialkyl borane and an alkyl cycloalkyl borane.

18. A method according to claim 15 wherein the organoborane part of the organoborane/amine complex is selected from a trialkyl borane and an alkyl cycloalkyl borane.

19. A method according to claim 2 wherein the seams are directly molded into the first panel portion.

20. A method according to claim 1 wherein the adhesive includes either a borane or a borate salt.

21. A method according to claim 1 wherein the first material is a filled or unfilled thermoplastic material.

22 A method according to claim 1 wherein the adhesive includes a urethane, an acrylonitrile butadiene styrene, a polycarbonate (PC), a silane, a silicone, an acrylic, an epoxy or a polyolefinic.
